(19) United States
(12) Patent Application Publication
(10) Pub. No.: US 2025/0357686 A1
(43) Pub. Date: Nov. 20, 2025

(54) TERMINAL BLOCK

(71) Applicant: Yazaki Corporation, Tokyo (JP)

(72) Inventors: Yasuhiro TANAKA, Shizuoka (JP); Yasuhiro Otsuta, Shizuoka (JP); Sota Arai, Shizuoka (JP); Masatoshi Yamada, Shizuoka (JP); Yusuke Tsutagawa, Shizuoka (JP); Katsuya Nakano, Shizuoka (JP)

(73) Assignee: Yazaki Corporation, Tokyo (JP)

(21) Appl. No.: 19/191,282

(22) Filed: Apr. 28, 2025

(30) Foreign Application Priority Data
May 20, 2024 (JP) 2024-081572

(51) Int. Cl. H01R 9/24

(52) U.S. Cl. CPC H01R 9/24

(57) ABSTRACT

A terminal block includes a bus bar and connected to an external terminal, a housing that holds the bus bar, and a fastening member that fastens the bus bar and the external terminal to the housing. The housing includes a first rotation stop portion that supports one end portion of the bus bar in a width direction and a second rotation stop portion that supports the other end portion of the bus bar in the width direction. The first rotation stop portion is provided, in an axial direction, at a position overlapping the fastening member in the width direction, and the second rotation stop portion is provided at a position separated from the fastening member and the first rotation stop portion in the axial direction.

### CROSS-REFERENCE TO RELATED APPLICATION(S)

The present application claims priority to and incorporates by reference the entire contents of Japanese Patent Application No. 2024-081572 filed in Japan on May 20, 2024.

### BACKGROUND OF THE INVENTION

### 1. Field of the Invention

The present invention relates to a terminal block.

### 2. Description of the Related Art

As a technique relating to a terminal block of a related art, for example, JP 2010-176 997 A discloses an assembled battery including a connection terminal (a bus bar) connected to a detection terminal, a housing that holds the connection terminal, a fastening member that fastens the connection terminal and the detection terminal to the housing, and a rotation preventing wall that prevents co-rotation of the connection terminal involved in the fastening of the fastening member. The rotation preventing wall is in contact with one end portion of the connection terminal on an inclined surface side and, on the other hand, is separated from the other end portion of the connection terminal on a horizontal surface side.

Incidentally, in the terminal block of this type, for example, there is room for further improvement in appropriately suppressing the co-rotation of the bus bar.

### SUMMARY OF THE INVENTION

The present invention has been made in view of the above circumstances, and an object of the present invention is to provide a terminal block that can appropriately suppress co-rotation of a bus bar.

In order to achieve the above mentioned object, a terminal block according to one aspect of the present invention includes a bus bar extending in an axial direction and connected to an external terminal; a housing that holds the bus bar; and a fastening member that fastens the bus bar and the external terminal to the housing in a fastening direction intersecting the axial direction, wherein the housing includes: a first rotation stop portion that supports one end portion of the bus bar in a width direction intersecting the axial direction and the fastening direction; and a second rotation stop portion that supports another end portion of the bus bar in the width direction, and the first rotation stop portion is provided, in the axial direction, at a position overlapping the fastening member in the width direction, and the second rotation stop portion is provided at a position separated from the fastening member and the first rotation stop portion in the axial direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary cross-sectional view of the terminal block according to the embodiment; and

FIG. 4 is an exemplary cross-sectional view of the terminal block according to the embodiment and is an enlarged view of a first rotation stop portion and a second rotation stop portion.

### DETAILED DESCRIPTION OF THE PREFERRED EMBODIMENTS

An embodiment according to the present invention is explained in detail below with reference to the drawings. Note that the present invention is not limited by the embodiment explained below. Components in the embodiment explained below include components that can be easily substituted by those skilled in the art or components that are substantially the same. In the present specification, ordinal numbers are used only to distinguish components, members, parts, positions, directions, and the like and do not indicate order and priority.

### Embodiment

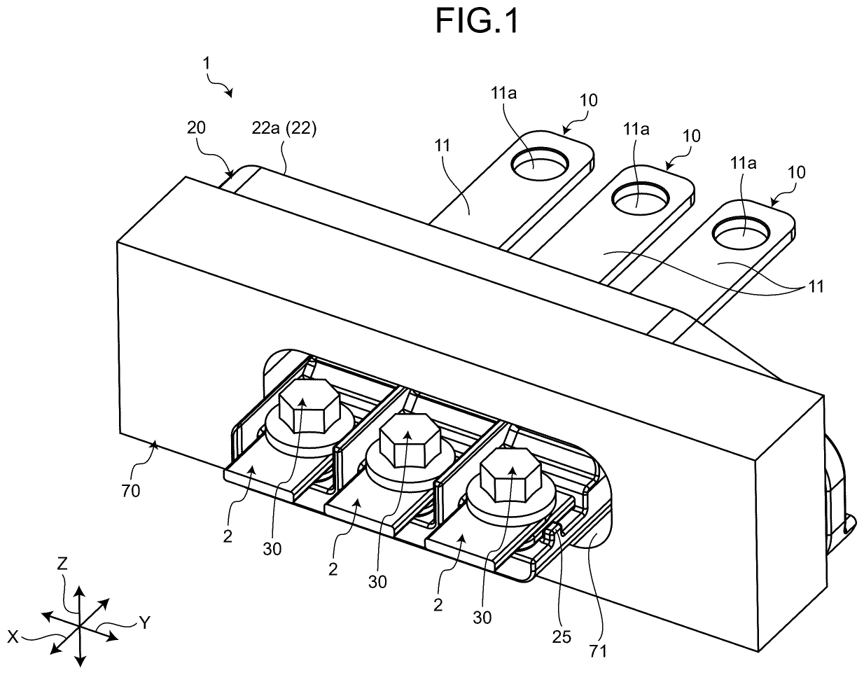

FIG. 1 is a perspective view of a terminal block 1 according to an embodiment. The terminal block 1 in the present embodiment illustrated in FIG. 1 is mounted on a vehicle such as an electric car or a hybrid car, is attached to an attachment target object 70, and relays electrical connection between a not-illustrated first device and a not-illustrated second device. The terminal block 1 in the present embodiment includes a plurality of bus bars 10. An external terminal of the first device is electrically connected to a first connecting portion 11 provided at one end portion of the plurality of bus bars 10. In the terminal block 1 in the present embodiment, an external terminal 2 of the second device is electrically connected to a second connecting portion 12 provided at the other end portion of the plurality of bus bars 10. The first device is, for example, one of a motor and an inverter and the second device is, for example, the other of the motor and the inverter. Note that the terminal block 1 is not limited to this example and may be used for, for example, relaying the first device or the second device and a routing material and relaying a routing material and a routing material.

In the following explanation, among a first direction, a second direction, and a third direction intersecting one another, the first direction is referred to as “axial direction X”, the second direction is referred to as “width direction Y”, and the third direction is referred to as “fastening direction Z”. Here, the axial direction X, the width direction Y, and the fastening direction Z are substantially orthogonal to each other. The axial direction X is typically equivalent to an extending direction of the plurality of bus bars 10, an insertion direction of the plurality of bus bars 10 into a housing 20, the depth direction (the front-rear direction) of the terminal block 1, and the like. The width direction Y is typically equivalent to the width direction of the plurality of bus bars 10, the width direction (the left-right direction) of the terminal block 1, and the like. The fastening direction Z is typically equivalent to the thickness direction of the plurality of bus bars 10, a fastening direction of the plurality of bus bars 10 and the external terminal 2, the height direction (the up-down direction) of the terminal block 1, and the like. The directions used in the following explanation are explained as directions in a state in which the terminal block 1 is attached to the attachment target object 70 unless particularly noted otherwise.

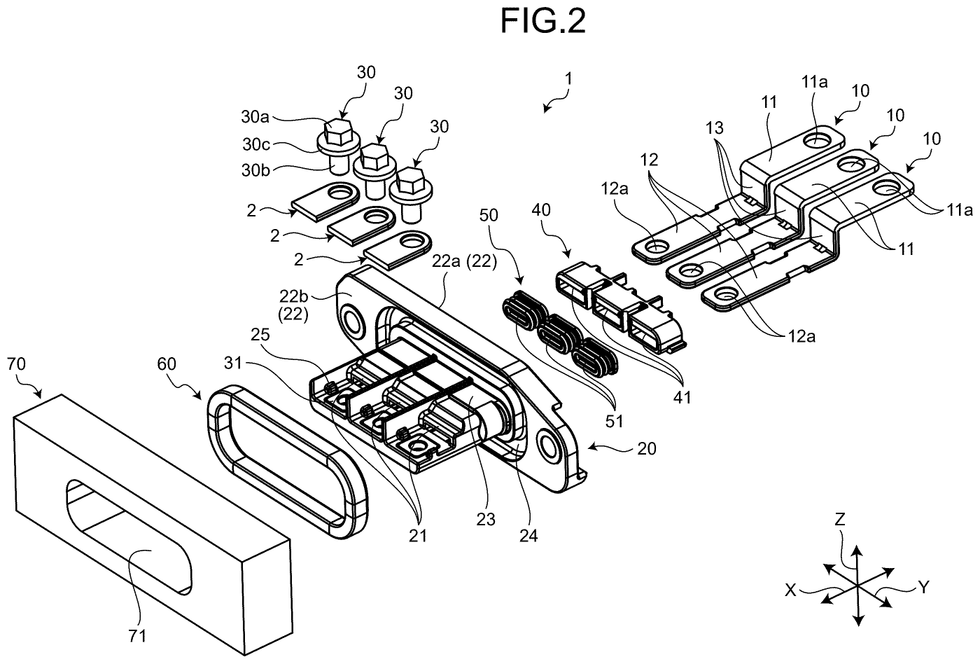

FIG. 2 is an exploded perspective view of the terminal block 1. As illustrated in FIG. 2, the terminal block 1 includes, for example, the bus bar 10, the housing 20, a fastening member 30, a packing holder 40, a packing 50, and a seal member 60. The bus bar 10 is a terminal metal fitting made of a conductive metal material and is electrically connected to the external terminal 2 described above. In the present embodiment, in the terminal block 1, three bus bars 10 are provided side by side in the width direction Y. The number of the bus bars 10 is not limited to this example. For example, one, two, or four or more bus bars 10 may be provided.

The bus bar 10 includes, for example, a first connecting portion 11 provided at one end portion in the axial direction X, a second connecting portion 12 provided at the other end portion in the axial direction X, and an intermediate portion 13 provided between the first connecting portion 11 and the second connecting portion 12. The first connecting portion 11, the second connecting portion 12, and the intermediate portion 13 are integrally formed of a conductive metal material. That is, in the bus bar 10, by applying various kinds of machining such as bending to one sheet metal according to shapes corresponding to the first connecting portion 11, the second connecting portion 12, and the intermediate portion 13, the sections are three-dimensionally integrally formed in a crank shape.

The first connecting portion 11 is a portion electrically and mechanically connected to the external terminal of the first device explained above. The first connecting portion 11 extends in the axial direction X. In the first connecting portion 11, an attachment hole 11a to which a fastening member such as a bolt that fastens the bus bar 10 and the external terminal is attached is provided. The attachment hole 11a is a through hole piercing through the first connecting portion 11 in the fastening direction Z and is configured as, for example, a round hole having substantially the same diameter as a shaft portion of the fastening member.

The second connecting portion 12 is a portion electrically and mechanically connected to the external terminal 2 of the second device explained above. The second connecting portion 12 extends in the axial direction X and is positioned to be shifted to the other end portion side in the axial direction X and in the fastening direction Z with respect to the first connecting portion 11. In the second connecting portion 12, an attachment hole 12a to which a fastening member 30 such as a bolt that fastens the bus bar 10 and the external terminal 2 is attached is provided. The attachment hole 12a is a through hole piercing through the second connecting portion 12 in the fastening direction Z and is configured as, for example, a round hole having substantially the same diameter as a shaft portion 30b of the fastening member 30.

The intermediate portion 13 is a portion connected between the first connecting portion 11 and the second connecting portion 12. The intermediate portion 13 includes a planar portion extending in the fastening direction Z and forms a step between the first connecting portion 11 and the second connecting portion 12. The intermediate portion 13 is formed to be bent, for example, at an angle of 90° with respect to the first connecting portion 11 and the second connecting portion 12. That is, in the present embodiment, substantially the entire intermediate portion 13 is configured as a planar section extending in the fastening direction Z. The thickness direction of the intermediate portion 13 is in the axial direction X intersecting the thickness direction of the first connecting portion 11 and the second connecting portion 12.

The housing 20 holds the second connecting portions 12 of the three bus bars 10 disposed side by side in the width direction Y and is formed of an insulating synthetic resin material or the like. The housing 20 includes, for example, a housing main body 22 and a housing protruding portion 23 protruding from the housing main body 22 to a side opposite to the bus bar 10 in the axial direction X. In the housing 20, the housing main body 22 and the housing protruding portion 23 are integrally formed.

An insertion hole 21 into which the second connecting portion 12 of the bus bar 10 is inserted in the axial direction X is provided on the inside of the housing main body 22 and the housing protruding portion 23. The insertion hole 21 is an opening (an insertion space portion) piercing through the housing main body 22 and the housing protruding portion 23 in the axial direction X. In the present embodiment, in the housing 20, three insertion holes 21 are provided to correspond to the bus bars 10. These three insertion holes 21 are partitioned from one another in the width direction Y.

The housing main body 22 includes one end face 22a facing one side (the bus bar 10 side) in the axial direction X and the other end face 22b facing the other side in the axial direction X. The one end face 22a is a portion facing the intermediate portion 13 of the bus bar 10 in the axial direction X at the peripheral edge portion of the insertion hole 21. The other end face 22b is a portion in which a recess 24 that holds the seal member 60 at the peripheral edge portion of the housing protruding portion 23 is provided. The recess 24 is recessed from the other end face 22b toward one side in the axial direction X and opened toward the other side in the axial direction X. The recess 24 is formed in, for example, a substantially elliptical annular shape along the external shape of the seal member 60.

The seal member 60 prevent foreign matters such as moisture from entering the inside of the terminal block 1 from an annular gap between the housing 20 and the attachment target object 70 explained above. The seal member 60 is formed of an elastically deformable member such as rubber or resin. The seal member 60 is formed in, for example, a substantially elliptical tubular shape and is inserted into the recess 24 explained above. The seal member 60 is interposed between the bottom surface of the recess 24 and one end face of the attachment target object 70 in the axial direction X in a state in which the terminal block 1 is attached to the attachment target object 70. Note that, in the attachment target object 70, a through hole 71 through which the housing protruding portion 23 is inserted in the axial direction X is provided.

The fastening member 30 fastens the bus bar 10 and the external terminal 2 to the housing 20 in the fastening direction Z. The fastening member 30 is configured by, for example, a bolt including a shaft portion 30b in which a male screw portion to be meshed with a female screw portion of a nut 31 is provided, a head portion 30a having a larger diameter than the shaft portion 30b, and a flange portion 30c (a washer) interposed between the head portion 30a and the external terminal 2. For example, the nut 31 is attached and fixed to the distal end portion of the housing protruding portion 23 in a state in which rotation is restricted. The nut 31 is aligned with the attachment hole 12a in the fastening direction Z according to the insertion of the second connecting portion 12 into the insertion hole 21. In the fastening member 30, in a state in which the second connecting portion 12 and the external terminal 2 are sandwiched between the head portion 30a and the nut 31, the shaft portion 30b pierces through the second connecting portion 12 and the external terminal 2 in the fastening direction Z and is fastened to the nut 31.

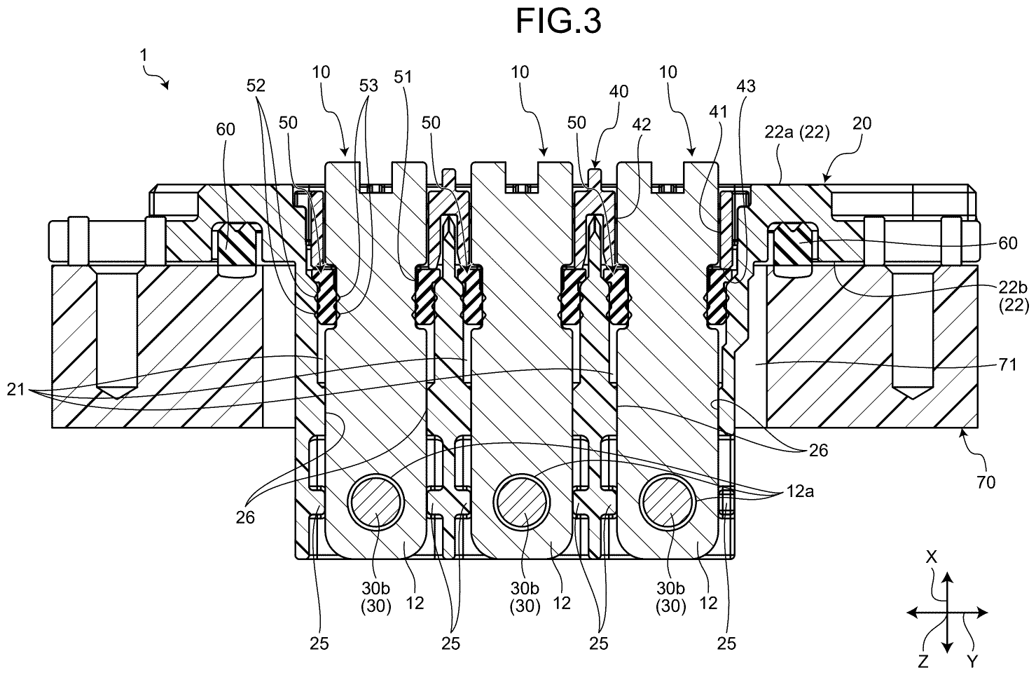

FIG. 3 is a cross-sectional view of the terminal block 1. As illustrated in FIGS. 2 and 3, the packing 50 includes, for example, an insertion hole 51 through which the second connecting portion 12 of the bus bar 10 is inserted in the axial direction X and seals the periphery of the second connecting portion 12 inserted through the insertion hole 51. In the present embodiment, in the terminal block 1, three packings 50 are provided to correspond to the bus bars 10. The packings 50 are formed of, for example, an elastically deformable member such as rubber. The packings 50 are also referred to as terminal packing, rubber plug, bush, or the like.

In each of the packings 50, a plurality of outer circumference side lip portions 52 and a plurality of inner circumference side lip portions 53 are provided. The outer circumference side lip portions 52 are pleated water stop portions formed in a substantially annular shape along the outer circumferential surfaces of the packings 50. In the present embodiment, in each of the packings 50, two outer circumference side lip portions 52 are provided side by side in the axial direction X. In a state in which the packings 50 are attached in the insertion hole 21 of the housing 20, the outer circumference side lip portions 52 come into contact with the inner surface of the insertion hole 21 and stop water between the outer circumference side lip portions 52 and the inner surface. The outer circumference side lip portions 52 are configured to adhere the inner surface of the insertion hole 21 with elastic deformation and seal an annular space between the inner surface and the outer circumferential surfaces of the packings 50.

The inner circumference side lip portions 53 are pleated water stop portions formed in a substantially annular shape along the inner circumferential surfaces of the packings 50. In the present embodiment, in each of the packings 50, two inner circumference side lip portions 53 are provided side by side in the axial direction X. In a state in which the second connecting portion 12 of the bus bar 10 is inserted (press-fit) in the insertion hole 51 of the packing 50, the inner circumference side lip portions 53 come into contact with the outer surface of the second connecting portion 12 and stops water between the inner circumference side lip portions 53 and the outer surface of the second connecting portion 12. The inner circumference side lip portions 53 are configured to adhere the outer surface of the second connecting portion 12 with elastic deformation and seal an annular space between the outer surface and the inner circumferential surface of the packing 50.

The packing holder 40 includes, for example, a bus bar insertion portion 41 through which the second connecting portion 12 of the bus bar 10 is inserted in the axial direction X, supports the periphery of the second connecting portion 12 inserted through the bus bar insertion portion 41, and supports the packing 50 in the axial direction X. In the present embodiment, in the packing holder 40, three bus bar insertion portions 41 are provided to correspond to the bus bars 10. The three bus bar insertion portions 41 are, for example, partitioned from one another in the width direction Y via a partition wall 42 provided between two bus bar insertion portions 41 adjacent to each other in the width direction Y. The packing holder 40 is formed of, for example, an insulating synthetic resin material.

The packing holder 40 includes, for example, an end face 43 facing the packing 50. The end face 43 is a portion that supports the packing 50 in the axial direction X. In the present embodiment, the packing holder 40 is inserted into the insertion hole 21 of the housing 20 in a state in which the second connecting portion 12 is inserted through the bus bar insertion portion 41 and the end face 43 is in contact with the packing 50. The packing holder 40 functions as a portion that pushes the packing 50 toward the other side in the axial direction X (the depth side of the insertion hole 21) when being assembled to the insertion hole 21.

Here, in the present embodiment, the housing 20 includes first rotation stop portions 25 and second rotation stop portions 26 that suppress co-rotation of the bus bars 10 involved in fastening of the fastening members 30. The first rotation stop portions 25 are portions that support one end portions of the bus bars 10 in the width direction Y and the second rotation stop portions 26 are portions that support the other end portions of the bus bars 10 in the width direction Y. That is, the first rotation stop portions 25 and the second rotation stop portions 26 mutually support the end portions of the bus bars 10 on the opposite sides in the width direction Y. In the present embodiment, the first rotation stop portions 25 and the second rotation stop portions 26 are provided to be separated from each other in the axial direction X.

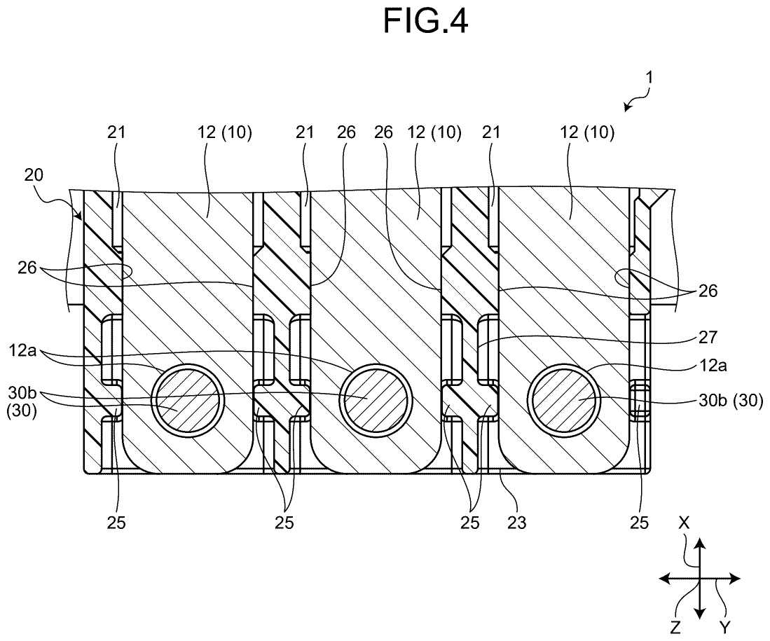

FIG. 4 is a cross-sectional view of the terminal block 1 and is an enlarged view of the first rotation stop portions 25 and the second rotation stop portions 26. As illustrated in FIG. 4, in the present embodiment, the second rotation stop portions 26 are provided on the inner side of the insertion holes 21 of the housing 20. The second rotation stop portion 26 is provided, for example, on the inner surfaces of the respective three insertion holes 21 and protrude from the inner surfaces toward sides approaching each other in the width direction Y (the bus bar 10 sides). That is, in the present embodiment, a pair of the second rotation stop portions 26 are provided on both sides in the width direction Y of the bus bar 10 in each insertion hole 21 of the housing 20.

In the present embodiment, one of the pair of second rotation stop portions 26 supports the other end portion (the right end portion in FIG. 4) of the bus bar 10 in the width direction Y and restricts, according to contact with the other end portion, rotation or inclination to one side (the clockwise direction in FIG. 4) in a rotation direction with the shaft portion 30b of the bus bar 10 set as a rotation center involved in a fastening operation of the fastening member 30. The other of the pair of second rotation stop portions 26 supports one end portion (the left end portion in FIG. 4) of the bus bar 10 in the width direction Y and restricts, according to contact with the one end portion, rotation or inclination to the other side (the counterclockwise direction in FIG. 4) in the rotation direction with the shaft portion 30b of the bus bar 10 set as the rotation center involved in a fastening release operation of the fastening member 30.

The first rotation stop portions 25 are provided on the outer side of the insertion holes 21 of the housing 20. The first rotation stop portions 25 are provided, for example, at the distal end portions of the housing protruding portions 23 and protrude from the distal end portion in the fastening direction Z. In the present embodiment, a pair of the first rotation stop portions 25 is provided on both sides in the width direction Y of the bus bars 10 with the fastening members 30 interposed therebetween at outlets of the insertion holes 21 of the housing 20. That is, in the present embodiment, the first rotation stop portions 25 are provided at positions overlapping, in the axial direction X, the fastening members 30 in the width direction Y and are separated from the second rotation stop portions 26 in the axial direction X. For example, the first rotation stop portion 25 is connected to a partition wall 27 located between two insertion holes 21 adjacent to each other in the width direction Y and protrudes from the partition wall 27 in the width direction Y.

In the present embodiment, one of the pair of first rotation stop portions 25 supports one end portion (the left end portion in FIG. 4) of the bus bar 10 in the width direction Y and restricts, according to contact with the one end portion, rotation or inclination to one side (the clockwise direction in FIG. 4) in a rotation direction with the shaft portion 30b of the bus bar 10 set as a rotation center involved in a fastening operation of the fastening member 30. The other of the pair of first rotation stop portions 25 supports the other end portion (the right end portion in FIG. 4) of the bus bar 10 in the width direction Y and restricts, according to contact with the other end portion, the rotation or inclination to the other side (the counterclockwise direction in FIG. 4) in the rotation direction with the shaft portion 30b of the bus bar 10 set as the rotation center involved in the fastening release operation of the fastening member 30.

As explained above, in the terminal block 1 in the present embodiment, the first rotation stop portion 25 is provided, in the axial direction X, at the position overlapping the fastening member 30 in the width direction Y and the second rotation stop portion 26 is provided at the position separated from the fastening member 30 and the first rotation stop portion 25 in the axial direction X. With this configuration, in the terminal block 1, for example, by suppressing, with the first rotation stop portion 25 and the second rotation stop portion 26, co-rotation of the bus bar 10 involved in fastening of the fastening member 30, stress caused by the co-rotation of the bus bar 10 can be dispersed to each of the first rotation stop portion 25 and the second rotation stop portion 26 and the stress can be prevented from locally concentrating on the housing 20. As a result, the terminal block 1 can properly suppress the co-rotation of the bus bar 10.

In the terminal block 1 according to the present embodiment, a pair of the first rotation stop portions 25 is provided on both sides of the bus bar 10 in the width direction Y with the fastening member 30 interposed therebetween and a pair of the second rotation stop portions 26 is provided on both sides of the bus bar 10 in the width direction Y in a state of being separated from the pair of first rotation stop portions 25. With this configuration, in the terminal block 1, for example, by the pair of first rotation stop portions 25 and the pair of second rotation stop portions 26, co-rotation of the bus bar 10 to one side in the rotation direction involved in the fastening operation of the fastening member 30 can be suppressed and co-rotation of the bus bar 10 to the other side in the rotation direction involved in the fastening release operation of the fastening member 30 can be suppressed. For example, compared with when the pair of first rotation stop portions 25 and the pair of second rotation stop portions 26 are integrally provided in the axial direction X without being separated from each other, it is possible to improve assemblability of the bus bar 10 to the housing 20.

In the terminal block 1 according to the present embodiment, the housing 20 includes the insertion hole 21 into which the bus bar 10 is inserted in the axial direction X, the second rotation stop portion 26 is provided on the inner side of the insertion hole 21, and the first rotation stop portion 25 is provided on the outer side of the insertion hole 21. With this configuration, in the terminal block 1, for example, by the first rotation stop portion 25 provided on the outer side of the insertion hole 21, when the bus bar 10 co-rotates, stress can be prevented from concentrating on the second rotation stop portion 26 serving as the inner wall of the insertion hole 21.

In the present embodiment, the case in which the second rotation stop portion 26 is provided on the inner side of the insertion hole 21 and the first rotation stop portion 25 is provided on the outer side of the insertion hole 21 is exemplified. However, without being limited to this example, for example, each of the first rotation stop portion 25 and the second rotation stop portion 26 may be provided on the outer side of the insertion hole 21.

Although the embodiment of the present invention is exemplified above, the embodiment explained above is merely an example and is not intended to limit the scope of the invention. The embodiment explained above can be implemented in various other forms, and various omissions, substitutions, combinations, and changes can be made without departing from the gist of the invention. Specifications (structure, type, direction, form, size, length, width, thickness, height, number, arrangement, position, material, and the like) of the components, the shapes, and the like can be changed as appropriate and implemented.

In the terminal block according to the present embodiment, the first rotation stop portion is provided at the position overlapping, in the width direction, the fastening member in the axial direction and the second rotation stop portion is provided at the position separated from the fastening member and the first rotation stop portion in the axial direction. With this configuration, in the terminal block, for example, by suppressing, with the first rotation stop portion and the second rotation stop portion, co-rotation of the bus bar involved in the fastening of the fastening member, the stress caused by the co-rotation of the bus bar can be dispersed to each of the first rotation stop portion and the second rotation stop portion and the stress can be prevented from locally concentrating on the housing. As a result, the terminal block achieves an effect that it is possible to properly suppress the co-rotation of the bus bars.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar extending in an axial direction and connected to an external terminal;
a housing that holds the bus bar; and
a fastening member that fastens the bus bar and the external terminal to the housing in a fastening direction intersecting the axial direction, wherein
the housing includes: a first rotation stop portion that supports one end portion of the bus bar in a width direction intersecting the axial direction and the fastening direction; and a second rotation stop portion that supports another end portion of the bus bar in the width direction, and
the first rotation stop portion is provided, in the axial direction, at a position overlapping the fastening member in the width direction, and the second rotation stop portion is provided at a position separated from the fastening member and the first rotation stop portion in the axial direction.

2. The terminal block according to claim 1, wherein
a pair of the first rotation stop portions is provided on both sides of the bus bar in the width direction with the fastening member interposed therebetween, and
a pair of the second rotation stop portions is provided on both sides of the bus bar in the width direction in a state of being separated from the pair of first rotation stop portions.

3. The terminal block according to claim 1, wherein
the housing includes an insertion hole into which the bus bar is inserted in the axial direction,
the second rotation stop portion is provided on an inner side of the insertion hole, and
the first rotation stop portion is provided on an outer side of the insertion hole.

4. The terminal block according to claim 2, wherein
the housing includes an insertion hole into which the bus bar is inserted in the axial direction,
the second rotation stop portion is provided on an inner side of the insertion hole, and
the first rotation stop portion is provided on an outer side of the insertion hole.
